(19) United States
(12) Patent Application Publication
(10) Pub. No.: US 2009/0292149 A1
(43) Pub. Date: Nov. 26, 2009

(54) CATALYST FOR LIQUEFIED PETROLEUM GAS PRODUCTION AND METHOD FOR PRODUCING LIQUEFIED PETROLEUM GAS USING THE CATALYST

(75) Inventors: Xiahong Li, Fukuoka (JP); Kaoru Fujimoto, Fukuoka (JP)

Correspondence Address: FOLEY AND LARDNER LLP;SUITE 500, 3000 K STREET NW, WASHINGTON, DC, 20007, US

(73) Assignee: JAPAN GAS SYNTHESIZE, LTD.

(21) Appl. No.: 12/375,766

(22) PCT Filed: Jul. 30, 2007
(86) PCT No.: PCT/JP2007/064862

§ 371 Date: Jan. 30, 2009

(30) Foreign Application Priority Data
Jul. 31, 2006 (JP) 2006-208124

(51) Int. Cl. C10L 3/00; B01J 29/068

(52) U.S. Cl. 585/6; 502/74

(57) ABSTRACT

It is an objective of the present invention to provide a catalyst with high LPG selectivity, which is used for the semi-indirect method for synthesizing a liquefied petroleum gas (LPG).

The present invention relates to a catalyst for liquefied petroleum gas production for producing a liquefied petroleum gas mainly consisting of propane or butane by reacting at least one of methanol and dimethyl ether with hydrogen, which comprises a Pd-loaded β-zeolite having an SiO₂:Al₂O₃ molar ratio of 100 or more:1.

### TECHNICAL FIELD

The present invention relates to a catalyst for producing a liquefied petroleum gas mainly consisting of propane or butane by reacting at least one of methanol and dimethyl ether with hydrogen and also relates to a method for producing a liquefied petroleum gas with the use of such catalyst.

In addition, the present invention relates to a method for producing a liquefied petroleum gas mainly consisting of propane or butane from methanol and/or dimethyl ether generated from a synthesis gas. Further, the present invention relates to a method for producing a liquefied petroleum gas mainly consisting of propane or butane from methanol and/or dimethyl ether generated from a carbon-containing starting material such as natural gas.

### BACKGROUND ART

The term “liquefied petroleum gas (LPG)” refers to liquid products obtained by compressing a petroleum-based or natural-gas-based hydrocarbon, which is present in a gas form at ordinary temperatures and pressures, with or without simultaneous cooling. A liquefied petroleum gas mainly contains propane or butane. LPGs that can be stored and transported in liquid form are excellent in terms of portability. Unlike the case of natural gas that needs to be supplied via pipelines, LPGs are characterized in that they can be supplied to any location when loaded into a cylinder. Therefore, an LPG mainly consisting of propane, namely, propane gas, has been widely used as a household/business-use fuel. At present, also in Japan, propane gas is supplied to approximately 25,000,000 households (over 50% of the total households). Further, LPGs have been used not only as household/business-use fuels but also as fuels (mainly containing butane gas) for portable devices or apparatuses such as portable gas stoves or disposable lighters, industrial-use fuels, and automobile fuels.

Hitherto, LPGs have been produced by the following methods and the like: 1): a method for recovering an LPG from a wet natural gas; 2): a method for recovering an LPG in a step of stabilizing crude oil (with vapor pressure control); and 3): a method for separating/extracting a product generated in a petroleum refining step.

LPGs, and in particular, propane gas used as a household/business-use fuel, are expected to be in demand in the future. Thus, the establishment of a novel method for producing an LPG in an industrially practicable manner is extremely useful.

Hitherto, the present inventors have studied a method for synthesizing an LPG mainly consisting of propane or butane from hydrogen and at least one of methanol and dimethyl ether according to the following formula (I). The present inventors called the method “the semi-indirect method.”

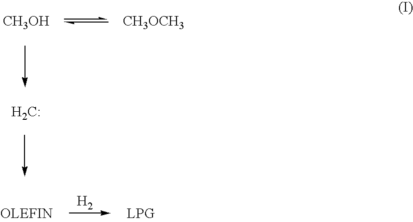

The reaction of the semi-indirect method involves a reaction for forming olefin from methanol or dimethyl ether (olefination reaction) and a reaction for forming paraffin (i.e., LPG) by subjecting olefin to hydrogenation (hydrogenation reaction).

Hitherto, the present inventors have examined a variety of catalysts to be used for the semi-indirect method (see Non-Patent Documents 1 to 3, etc.). However, satisfactory levels of LPG selectivity have not been realized with the use of semi-indirect method catalysts that have so far been developed.

For example, Non-Patent Document 1 discloses, as a semi-indirect method catalyst, a hybrid catalyst containing a combination of Pd-loaded silica and USY zeolite. However, the conversion rate of dimethyl ether into industrially useless carbon monoxide and carbon dioxide reaches a level of approximately several percent, which is problematic. In addition, the combined proportion of propane and butane contained in produced hydrocarbon was approximately 65% at most.

Further, in the cases of the conventional semi-indirect method catalysts, it has been common to combine a catalyst that promotes an olefination reaction and a catalyst that promotes a reaction in which olefin is subjected to hydrogenation so as to be converted into paraffin. Thus, complicated production steps are required in the cases of the conventional semi-indirect method catalysts, which is problematic. For instance, Non-Patent Document 1 describes an experiment in which a Pd-loaded β-zeolite catalyst having an SiO₂:Al₂O₃ molar ratio of 37:1 alone was used to produce an LPG from dimethyl ether and hydrogen. However, the hydrocarbon yield was 73.6% and the combined proportion of propane and butane contained in hydrocarbon was 2.1%, which was very low. Therefore, the obtained product was not industrially applicable.

Non-Patent Document 1: K. Asami et al. Catalysis Today, 106 (2005) 247-251

Non-Patent Document 2: Kenji Asami, Qianwen Zhang, Hirashima Shunsuke, Xiaohong Li, Sachio Asaoka, Kaoru Fujimoto, the 47^{th} annual meeting (the 53^{rd} meeting for research presentation) of the Japan Petroleum Institute, May 2004, Tokyo

Non-Patent Document 3: Kenji Asami, Qianwen Zhang, Hirashima Shunsuke, Xiaohong Li, Sachio Asaoka, Kaoru Fujimoto, Synthesis of LPG from DME with VIIIB Metal Supported on ZSM-5, the 13^{th} annual meeting of the Japan Institute of Energy (meeting for research presentation), July 2004, Tokyo

### DISCLOSURE OF THE INVENTION

### Problem to be Solved by the Invention

For the semi-indirect method, it has been desired to increase the hydrocarbon yield by reducing production of carbon monoxide and carbon dioxide and to increase the combined proportion of propane and butane contained in the hydrocarbon.

Therefore, it is an objective of the present invention to provide a catalyst with which a hydrocarbon mainly consisting of propane or butane (i.e., liquefied petroleum gas (LPG)) can be produced using, as starting materials, hydrogen and at least one of methanol and dimethyl ether with high selectivity and high yield.

It is another objective of the present invention to provide a method whereby a liquefied petroleum gas (LPG) can be produced with high selectivity and high yield.

### Means for Solving Problem

The present invention encompasses the following inventions.

(1) A catalyst for liquefied petroleum gas production for producing a liquefied petroleum gas mainly consisting of propane or butane by reacting at least one of methanol and dimethyl ether with hydrogen, which comprises a Pd-loaded β-zeolite having an SiO₂:Al₂O₃ molar ratio of 100 or more:1.
(2) The catalyst for liquefied petroleum gas production according to (1), wherein the SiO₂:Al₂O₃ molar ratio is 100:1 to 1000:1.
(3) The catalyst for liquefied petroleum gas production according to (1) or (2), wherein the loaded Pd content is 0.01% to 5.0% by weight.
(4) A method for liquefied petroleum gas production, comprising reacting at least one of methanol and dimethyl ether with hydrogen in the presence of the catalyst for liquefied petroleum gas production according to any one of (1) to (3) so as to produce a liquefied petroleum gas mainly consisting of propane or butane.
(5) The method for liquefied petroleum gas production according to (4), wherein the reaction temperature for reacting at least one of methanol and dimethyl ether with hydrogen is 350° C. to 600° C.
(6) The method for liquefied petroleum gas production according to (4) or (5), wherein the reaction pressure for reacting at least one of methanol and dimethyl ether with hydrogen is 0.5 to 5.0 MPa.
(7) A method for liquefied petroleum gas production, comprising:

(A): a methanol production step of allowing a synthesis gas to flow through a catalyst layer containing a methanol synthesis catalyst so as to obtain a reaction gas containing methanol and hydrogen; and

(B): a liquefied petroleum gas production step of allowing the reaction gas obtained in the methanol production step to flow through a catalyst layer containing the catalyst for liquefied petroleum gas production according to any one of (1) to (3) so as to produce a liquefied petroleum gas mainly consisting of propane or butane.

(8) A method for liquefied petroleum gas production, comprising:

(A): a dimethyl ether production step of allowing a synthesis gas to flow through a catalyst layer containing a methanol synthesis catalyst and a methanol dehydration catalyst so as to obtain a reaction gas containing dimethyl ether and hydrogen; and

(B): a liquefied petroleum gas production step of allowing the reaction gas obtained in the dimethyl ether production step to flow through a catalyst layer containing the catalyst for liquefied petroleum gas production according to any one of (1) to (3) so as to produce a liquefied petroleum gas mainly consisting of propane or butane.

(9) A method for liquefied petroleum gas production, comprising:

(A): a synthesis gas production step of producing a synthesis gas with the use of a carbon-containing starting material and at least one member selected from the group consisting of H₂O, O₂, and CO₂;

(B): a methanol production step of allowing the synthesis gas to flow through a catalyst layer containing a methanol synthesis catalyst so as to obtain a reaction gas containing methanol and hydrogen; and

(C): a liquefied petroleum gas production step of allowing the reaction gas obtained in the methanol production step to flow through a catalyst layer containing the catalyst for liquefied petroleum gas production according to any one of (1) to (3) so as to produce a liquefied petroleum gas mainly consisting of propane or butane.

(10) A method for liquefied petroleum gas production, comprising:

(A): a synthesis gas production step of producing a synthesis gas with the use of a carbon-containing starting material and at least one member selected from the group consisting of H₂O, O₂, and CO₂;

(B): a dimethyl ether production step of allowing the synthesis gas to flow through a catalyst layer containing a methanol synthesis catalyst and a methanol dehydration catalyst so as to obtain a reaction gas containing dimethyl ether and hydrogen; and

(C): a liquefied petroleum gas production step of allowing the reaction gas obtained in the dimethyl ether production step to flow through a catalyst layer containing the catalyst for liquefied petroleum gas production according to any one of (1) to (3) so as to produce a liquefied petroleum gas mainly consisting of propane or butane.

The term “synthesis gas” used herein refers to a mixed gas containing hydrogen and carbon monoxide, and it is not limited to a mixed gas consisting of hydrogen and carbon monoxide. Such a synthesis gas may be, for example, a mixed gas containing carbon dioxide, water, methane, ethane, ethylene, or the like. A synthesis gas obtained by modifying natural gas generally contains not only hydrogen and carbon monoxide but also carbon dioxide and water vapor. In addition, the synthesis gas may be a coal gas obtained via coal gasification or a liquid gas produced from coal coke.

### EFFECTS OF THE INVENTION

According to the present invention, a catalyst with which a hydrocarbon mainly consisting of propane or butane (i.e., liquefied petroleum gas (LPG)) can be produced using, as starting materials, hydrogen and at least one of methanol and dimethyl ether with high selectivity and high yield is provided.

According to the present invention, a method whereby a liquefied petroleum gas (LPG) can be produced with high selectivity and high yield is provided.

This description includes part or all of the contents as disclosed in the description and/or drawings of Japanese Patent Application No. 2006-208124, which is a priority document of the present application.

### BRIEF DESCRIPTION OF THE DRAWINGS

FIG. 1 shows the hydrocarbon composition (%) of each hydrocarbon gas produced at each time point after the initiation of the flow of a starting material gas containing hydrogen and dimethyl ether at a hydrogen to dimethyl ether molar ratio of 19:1 through a catalyst layer containing β-zeolite being loaded with Pd (0.5% by weight) and having an SiO₂:Al₂O₃ molar ratio of 300:1 in Experiment 2.

### BEST MODE FOR CARRYING OUT THE INVENTION

### 1. A Catalyst for Liquefied Petroleum Gas Production

The catalyst for liquefied petroleum gas production of the present invention is characterized in that it contains a Pd-loaded β-zeolite having an SiO₂:Al₂O₃ molar ratio of 100 or more:1. Most of the conventional semi-indirect method catalysts are obtained by combining a catalyst for converting at least one of methanol and dimethyl ether into olefin and a catalyst for adding hydrogen to olefin. However, surprisingly, it is possible to carry out the reaction of the semi-indirect method with the use of a single catalyst according to the present invention.

The β-zeolite used in the present invention has an SiO₂:Al₂O₃ molar ratio of 100 or more:1, preferably 100:1 to 1000:1, more preferably 100:1 to 400:1, and most preferably 150:1 to 300:1. When the ratio is less than 100:1, the combined proportion of propane and butane contained in produced hydrocarbon is lowered, which is problematic. In addition, when the ratio exceeds 1000:1, hydrogenation of olefin, which is an intermediate product, is unlikely to proceed in some cases. β-zeolite having the above SiO₂:Al₂O₃ molar ratio can be prepared by a known method described in a reference (e.g., Synthesis and thermal stability of beta zeolite using ammonium fluoride, Hery Jon, Baowang Lu, Yasunori Oumi, Kenji Itabashi, Tsuneji Sano, Microporous Mesoporous Materials, 89 (2006) 88-95).

The β-zeolite used in the present invention is loaded with Pd. The loaded Pd content is not particularly limited; however, it is typically 0.01% to 5.0% by weight and more typically 0.1% to 5.0% by weight. When the loaded Pd content is less than 0.01%, a hydrogenation reaction of olefin is unlikely to proceed in some cases. Further, deposition of carbon contained in a catalyst is likely to occur in some cases. In the cases of excessive loaded Pd content, methane and ethane are likely to be produced. In addition, the cost itself is increased in such cases.

The loaded Pd content (% by weight) is defined as follows.

Loaded Pd content (% by weight)=[(Pd weight)/(Pd weight+β-zeolite weight)]×100

A method for introducing Pd into a zeolite catalyst is not particularly limited. Such introduction can be carried out by an ion-exchange method, an immersion method, and the like.

Pd is not required be contained in a metallic form. For example, it may be contained in the form of an oxide, nitrate, chloride, or the like. In such case, in view of obtaining higher catalyst activity, it is preferable to convert Pd in a zeolite catalyst into metal palladium by a hydrogen reduction treatment or the like prior to reaction.

The above β-zeolite can be used in a powder form. In addition, it can be subjected to molding according to need. Examples of a molding method include an extrusion molding method and a molding method involving tablet making.

### 2. A Method for Liquefied Petroleum Gas Production

Next, a method for producing a liquefied petroleum gas mainly consisting of propane or butane, and preferably of propane, by reacting at least one of methanol and dimethyl ether with hydrogen with the use of the catalyst for liquefied petroleum gas production of the present invention is described.

In the present invention, at least one of methanol and dimethyl ether is reacted with hydrogen. At least one of methanol and dimethyl ether is referred to as a “reaction starting material.”

For the LPG production method of the present invention, methanol or dimethyl ether alone can be used as a reaction starting material. Also, a mixture of methanol and dimethyl ether can be used. In a case in which a mixture of methanol and dimethyl ether is used as a reaction starting material, the content of methanol and of dimethyl ether in the mixture are not particularly limited and they can be adequately determined.

The reaction can be carried out with the use of a fixed bed, a fluidized bed, or a moving bed. Reaction conditions including the starting material gas composition, the reaction temperature, the reaction pressure, and the time period for contact with a catalyst can be adequately determined. For instance, an LPG synthesis reaction can be carried out under the following conditions.

The reaction temperature is preferably 350° C. to 600° C., more preferably 350° C. to 500° C., further preferably 415° C. to 500° C., and particularly preferably 430° C. to 500° C. When the reaction temperature is 350° C. or more, more preferably 415° C. or more, and particularly preferably 430° C. or more, sufficiently high levels of catalyst activity can be obtained. When the reaction temperature is 600° C. or less, C1 and C2 are unlikely to be produced. Such temperature range is higher than the reaction temperature for the conventional semi-indirect method. However, a β-zeolite catalyst is highly stable so as to be sufficiently durable in the above temperature range. In addition, the USY zeolite catalyst used in Non-Patent Document 1 has low stability at high temperatures and thus it is not applicable for use in a reaction within the above temperature range.

The reaction pressure is preferably 0.5 to 5.0 MPa and more preferably 0.5 to 3.0 MPa. When it is less than 0.5 MPa, an unstable reaction might take place.

The value (W/F value) obtained by dividing the amount of a catalyst used for reacting at least one of methanol and dimethyl ether with hydrogen (W) (units: “g”) by the inlet gas flow rate (F) (units: “mol/h”) is preferably 0.5 to 10.0. When the W/F value is 0.5 or more, high conversion rates are obtained. When the W/F value is 10.0 or less, small amounts of a catalyst can be used.

In a case in which a mixed gas containing methanol and hydrogen is used as a starting material gas, the amount of methanol in the starting material gas is preferably 0.04 mole to 1 mole and more preferably 0.1 mole to 0.4 mole with respect to 1 mole of hydrogen gas.

In a case in which a mixed gas containing dimethyl ether and hydrogen is used as a starting material gas, the amount of dimethyl ether in the starting material gas is preferably 0.02 mole to 0.5 mole and more preferably 0.05 mole to 0.2 mole with respect to 1 mole of hydrogen gas.

In a case in which a reaction starting material is a mixture of methanol and dimethyl ether, it is preferable that the concentrations of methanol and dimethyl ether in a gas that is introduced into a reactor and the concentration of hydrogen in a gas that is introduced into a reactor be within a range similar to the range preferable for the case of the use of methanol as a reaction starting material or the range preferable for the case of the use of dimethyl ether as a reaction starting material. For such case, preferable ranges can be calculated in accordance with the content of methanol and of dimethyl ether. For instance, given that “A” moles of methanol, “B” moles of dimethyl ether, and “C” moles of hydrogen are used, the proportion of methanol with respect to 1 mole of hydrogen gas is calculated by the following formula: A/{C*A/(A+B)}. Also, the proportion of dimethyl ether with respect to 1 mole of hydrogen gas is calculated by the following formula B/{C*B/(A+B)}. It is preferable to predetermine the above proportions within the aforementioned ranges.

A gas that is introduced into a reactor may contain, for example, water, an inert gas, and the like, in addition to hydrogen and at least one of methanol and dimethyl ether serving as reaction starting materials. In addition, a gas that is introduced into a reactor may contain carbon monoxide and/or carbon dioxide.

Further, hydrogen and at least one of methanol and dimethyl ether may be mixed and supplied into a reactor. Alternatively, they may be separately supplied into a reactor.

It is possible to control the reaction temperature by dividing a gas to be introduced into a reactor and introducing divided portions of the gas separately into the reactor.

The reaction can be carried out with the use of a catalyst bed such as a fixed bed, a fluidized bed, or a moving bed. Such catalyst bed is preferably selected in view of both reaction temperature control and catalyst reproduction method. For instance, examples of a fixed bed reactor that can be used include a quench-type reactor employing an internal multiple quench system, a multitubular reactor, a multiple reactor accommodating a plurality of heat exchangers, and other reactors employing a multiple cooling radial flow system, a double-tube heat exchange system, a built-in cooling coil system, a mixed flow system, and the like.

For the purpose of temperature control, it is possible to use the catalyst for liquefied petroleum gas production diluted with silica, alumina, or an inert and stable heat conductor. Further, for the purpose of temperature control, it is possible to use the catalyst for liquefied petroleum gas production applied to the surface of a heat exchanger.

In the case of the thus obtained gas generated by reaction (gas containing lower paraffin), a hydrocarbon contained therein mainly consists of propane or butane. In view of liquefaction characteristics, it is more preferable that the total content of propane and butane in a gas containing lower paraffin is larger. In the case of a gas containing lower paraffin that can be obtained by the present invention, the total content of propane and butane is 70% or more, preferably 75% or more, and more preferably 80% or more in terms of the carbon content in the hydrocarbon contained in the gas.

Further, in view of flammability and vapor pressure characteristics, it is preferable for the obtained gas containing lower paraffin to contain more propane than butane.

Moreover, in general, the obtained gas containing lower paraffin contains moisture, a low-boiling-point component that is a substance having a boiling or sublimation point lower than the boiling point of propane, and a high-boiling-point component that is a substance having a boiling point higher than the boiling point of butane. Examples of a low-boiling-point component include hydrogen remaining as an unreacted starting material and by-products such as ethane, methane, carbon monoxide, and carbon dioxide. Examples of a high-boiling-point component include by-products such as high-boiling-point paraffins (e.g., pentane and hexane).

Therefore, moisture, a low-boiling-point-component, a high-boiling-point component, and the like are separated from the obtained gas containing lower paraffin according to need such that a liquefied petroleum gas (LPG) mainly consisting of propane or butane is obtained. In addition, if necessary, methanol and/or dimethyl ether remaining as unreacted starting materials are separated therefrom by a conventional method.

Separation of moisture, a low-boiling-point component, and a high-boiling-point component can be carried out by a conventional method.

Separation of moisture can be carried out by, for example, liquid-liquid separation.

Separation of a low-boiling-point component can be carried out by, for example, gas-liquid separation, absorption separation, or distillation. More specifically, separation can be carried out by gas-liquid separation or absorption separation involving pressurization at normal temperature, gas-liquid separation or absorption separation involving cooling, or any combination thereof. In addition, separation can be carried out by membrane separation or adsorption separation. Further, such separation can be used in combination with gas-liquid separation, absorption separation, or distillation. For separation of a low-boiling-point component, a gas recovery process (described in “Petroleum Refinery Process (Sekiyu Seisei Process),” edited by the Japan Petroleum Institute, Kodansha Scientific Ltd., 1998, p. 28 to p. 32) that is usually used in refineries can be applied.

For a method for separating a low-boiling-point component, an absorption process is preferably used, in which a liquefied petroleum gas mainly consisting of propane or butane is absorbed by paraffin gas having a boiling point higher than that of butane or by an absorbent solution such as gasoline.

Separation of a high-boiling-point component can be carried out by, for example, gas-liquid separation, absorption separation, or distillation.

In addition, separation conditions can be adequately determined according to a conventional method.

Further, in order to obtain a liquefied petroleum gas, pressurization and/or cooling may be carried out according to need.

For consumer products, in view of safety for use, the content of a low-boiling-point component in an LPG is adjusted to preferably 5 mole % or less (including 0 mole %), for example, by separation.

The total content of propane and butane in the thus produced LPG can be 90% or more and, further, 95% or more (including 100%) in terms of carbon content. In addition, the content of propane in the thus produced LPG can be 50% or more, 60% or more, and, further, 65% or more (including 100%) in terms of carbon content. According to the present invention, an LPG having a composition appropriate for propane gas that is widely used as a household/business-use fuel can be produced.

### 3. A Method for Liquefied Petroleum Gas Production from Carbon-Containing Starting Materials

Currently, methanol and dimethyl ether used as reaction starting materials in the present invention are industrially produced.

For instance, methanol is produced as follows.

First, catalyst-poisoning substances such as sulfur and sulfur compounds are removed (by desulfurization or the like) according to need. Then, a synthesis gas is produced by reacting at least one member selected from the group consisting of a natural gas (methane), H₂O, O₂, and CO₂ in the presence of a reforming catalyst such as a Ni-based catalyst. Well-known examples of a method for producing a synthesis gas are a water vapor reforming method for a natural gas (methane), a combined reforming method, and an auto-thermal reforming method.

In addition, it is also possible to produce a synthesis gas by reacting a carbon-containing starting material that is not a natural gas with at least one member selected from the group consisting of H₂O, O₂, and CO₂. Any carbon-containing starting material can be used as long as it is a carbon-containing substance and it can react with at least one member selected from the group consisting of H₂O, O₂, and CO₂ such that H₂ and CO can be generated. Examples of such substance that can be used include a lower hydrocarbon (e.g., ethane), naphtha, and coal.

Next, methanol is produced from a synthesis gas by reacting carbon monoxide with hydrogen in the presence of a methanol synthesis catalyst. In a case in which a Cu—Zn-based catalyst (composite oxide containing Cu and Zn) such as a Cu—Zn—Al composite oxide or a Cu—Zn—Cr composite oxide is used as a methanol synthesis catalyst, a reaction is carried out generally at a reaction temperature of approximately 230° C. to 300° C. and at a reaction pressure of approximately 2 to 10 MPa. In a case in which a Zn—Cr-based catalyst (composite oxide containing Zn and Cr) is used as a methanol synthesis catalyst, a reaction is carried out generally at a reaction temperature of approximately 250° C. to 400° C. and at a reaction pressure of approximately 10 to 60 MPa.

In general, the thus obtained product (unrefined methanol) contains water, carbon monoxide remaining as an unreacted starting material, and by-products such as carbon dioxide and dimethyl ether. In the present invention, an unrefined methanol can be used as a reaction starting material.

Meanwhile, dimethyl ether is produced by a methanol dehydration reaction with the use of, for example, a solid acid catalyst such as aluminum phosphate.

Further, a process for producing dimethyl ether directly from a synthesis gas without generation of methanol during production is being developed for practical application. In this process, dimethyl ether can be synthesized using a slurry phase reactor by reacting carbon monoxide with hydrogen at a reaction temperature of approximately 230° C. to 280° C. and at a reaction pressure of 3 to 7 MPa in the presence of a mixed catalyst of a methanol synthesis catalyst and a methanol dehydration catalyst such as a catalyst containing a methanol synthesis catalyst and a methanol dehydration catalyst at a methanol synthesis catalyst:methanol dehydration catalyst ratio of 1:2 to 2:1 (mass ratio).

In general, the thus obtained product (unrefined dimethyl ether) contains water, carbon monoxide remaining as an unreacted starting material, by-products such as carbon dioxide and methanol, and the like. In the present invention, it is also possible to use an unrefined dimethyl ether as a reaction starting material.

Also, according to the present invention, a synthesis gas is produced from at least one member selected from the group consisting of carbon-containing starting materials, H₂O, O₂, and CO₂ (synthesis gas production step). The obtained synthesis gas is allowed to flow through a catalyst layer containing a methanol synthesis catalyst such that a reaction gas containing methanol and hydrogen is obtained (methanol production step). Then, the reaction gas obtained in the methanol production step is allowed to flow through the catalyst layer containing a catalyst for liquefied petroleum gas production according to the aforementioned method and thus a liquefied petroleum gas mainly consisting of propane or butane can be produced (liquefied petroleum gas production step).

Further, according to the present invention, a synthesis gas is produced from at least one member selected from the group consisting of carbon-containing starting materials, H₂O, O₂, and CO₂ (synthesis gas production step). The obtained synthesis gas is allowed to flow through a catalyst layer containing a methanol synthesis catalyst and a methanol dehydration catalyst such that a reaction gas containing dimethyl ether and hydrogen is obtained (dimethyl ether production step). Then, the reaction gas obtained in the dimethyl ether production step is allowed to flow through the catalyst layer containing a catalyst for liquefied petroleum gas production according to the aforementioned method, and thus a liquefied petroleum gas mainly consisting of propane or butane can be produced (liquefied petroleum gas production step).

Synthesis reaction of a synthesis gas may be carried out in accordance with a known method such as the aforementioned method. Also, a methanol synthesis reaction and a dimethyl ether synthesis reaction may be carried out in accordance with a known method such as the method described above.

In the above LPG production method, a shift reactor is installed downstream of a reformer serving as a reactor for producing a synthesis gas such that the composition of the synthesis gas can also be controlled by shift reaction (CO+H₂O→CO₂+H₂).

In addition, according to the above LPG production method, it is also possible to recycle a low-boiling-point component separated from a gas containing a lower paraffin in the liquefied petroleum gas production step as a starting material used in the synthesis gas production step.

A low-boiling-point component separated from a gas containing lower paraffin may be entirely recycled in the synthesis gas production step. Alternatively, a portion thereof is extracted from the system and the remaining portion may be recycled in the synthesis gas production step. It is also possible to recycle a low-boiling-point component in the synthesis gas production step after separating desired components alone therefrom.

In such case, the content of a low-boiling-point component in a gas introduced into a reformer serving as a reactor (i.e., the content of a starting material for recycling) can be adequately determined in the synthesis gas production step.

For recycling of a low-boiling-point component, it is possible to use a known technique for adequately providing a pressure increasing means to recycling lines, for example.

According to the present invention, a liquefied petroleum gas can be produced from a synthesis gas or a carbon-containing starting material such as natural gas or the like by using an existing methanol synthesis plant or dimethyl ether synthesis plant and applying the LPG production apparatus of the present invention thereto.

### EXAMPLES

The present invention is hereafter described in greater detail with reference to the following examples, although the technical scope of the present invention is not limited thereto.

### Experiment 1

In this Experiment, β-zeolite having an SiO₂:Al₂O₃ molar ratio of 37:1, 150:1, or 243:1 was used. β-zeolite as a product of Tosoh Corporation having an SiO₂:Al₂O₃ molar ratio of 37:1 was used. β-zeolite having an SiO₂:Al₂O₃ molar ratio of 150:1 that was prepared by the present inventors was used. Also, β-zeolite having an SiO₂:Al₂O₃ molar ratio of 243:1 that was prepared by the present inventors was used.

The β-zeolite having an SiO₂:Al₂O₃ molar ratio of 150:1 was prepared by the following procedures. Materials described below were used for preparation: deionized water; a 35% by weight aqueous solution of tetraethylammoniumhydroxide (TEAOH) (SIGMA-ALDRICH); Silica LUDOX TM-40 (a 40% by weight suspension in water of colloidal silica) (SIGMA-ALDRICH); sodium aluminate (Na₂O: 31% to 35% by weight; Al₂O₃: 34% to 39% by weight; Na₂O:Al₂O₃=1.5:1 (molar ratio)) (Kanto Chemical Co., Inc., Cat. No. 37095-01); and ammonium fluoride (Kanto Chemical Co., Inc.). First, sodium aluminate (0.3164 g), a TEAOH aqueous solution (21.28 g), and deionized water (3.15 g) were mixed so as to be homogenized. Next, Silica LUDOX TM-40 (25.375 g) was added to the above mixture, followed by stirring and mixing for dissolution. Further, ammonium fluoride (0.63 g) was added thereto, followed by stirring and mixing for 10 minutes. The thus obtained batch mixture had the composition of Na₂O:TEAOH:Al₂O₃:SiO₂:H₂O:NH₄F=0.01:36:1:150:1285:1.5 (molar ratio). The batch mixture was placed in an autoclave and subjected to hydrothermal synthesis at a rate of rotation of 13 rpm and at 150±1° C. for 96 hours. 96 hours later, the autoclave was cooled with cold water. The content was subjected to suction filtration. The resultant was sufficiently washed with deionized water and dried overnight at 120° C. After drying, baking was carried out at 550° C. for 5 hours. The thus obtained product was confirmed to be β-zeolite with the use of an X-ray diffractometer.

β-zeolite having an SiO₂:Al₂O₃ molar ratio of 243:1 was prepared by the following procedures. Materials described above were used for preparation. First, sodium aluminate (0.4 g), a TEAOH aqueous solution (42.5 g), and deionized water (6.3 g) were mixed so as to be homogenized. Next, Silica LUDOX TM-40 (50.75 g) was added to the above mixture, followed by stirring and mixing for dissolution. Further, ammonium fluoride (0.155 g) was added thereto, followed by stirring and mixing for 10 minutes. The thus obtained batch mixture had the composition of Na₂O: TEAOH:Al₂O₃:SiO₂:H₂O:NH₄F=0.01:36:0.4938:120:1285:1.5 (molar ratio). The batch mixture was placed in an autoclave and subjected to hydrothermal synthesis at a rate of rotation of 13 rpm and at 150±1° C. for 120 hours. 120 hours later, the autoclave was cooled with cold water. The content was subjected to suction filtration. The resultant was sufficiently washed with deionized water and dried overnight at 120° C. After drying, baking was carried out at 550° C. for 5 hours. The thus obtained product was confirmed to be β-zeolite with the use of an X-ray diffractometer.

These samples of β-zeolite were loaded with Pd. Pd loading on zeolite by an ion-exchange method was carried out by the following method. First, a Pd(NO₃)₂ solution was prepared at a concentration corresponding to the amount of Pd for loading. Zeolite powder (5 g) was added to the solution (150 ml), followed by stirring at 80° C. for 8 hours with the use of a water bath. After stirring, filtration was carried out to recover a catalyst. The recovered catalyst was dried at 120° C. in an open system. Subsequently, sintering was carried out at 500° C. for 4 hours in air. The loaded Pd content was 0.05% by weight, 0.1% by weight, or 0.5% by weight as shown in table 1.

The prepared Pd-loaded β-zeolite catalyst in a powder form was subjected to pressure molding at 40 kg/cm² for 30 seconds with the use of a tablet-molding machine and then was disrupted into 0.37- to 0.84-mm particles.

β-zeolite being loaded with Pd (0.05% by weight) and having an SiO₂:Al₂O₃ molar ratio of 37:1 was used in Comparative Example 1. β-zeolite being loaded with Pd (0.1% by weight) and having an SiO₂:Al₂O₃ molar ratio of 37:1 was used in Comparative Example 2. β-zeolite being loaded with Pd (0.5% by weight) and having an SiO₂:Al₂O₃ molar ratio of 37:1 was used in Comparative Example 3. β-zeolite being loaded with Pd (0.5% by weight) and having an SiO₂:Al₂O₃ molar ratio of 150:1 was used in Example 1. β-zeolite being loaded with Pd (0.5% by weight) and having an SiO₂:Al₂O₃ molar ratio of 243:1 was used in Example 2.

Reaction tubes each with an inner diameter of 6 mm were each filled with a different catalyst (1 g) prepared above. Prior to reaction, each catalyst was subjected to reduction treatment in a hydrogen stream at 400° C. for 2 hours.

After each catalyst was subjected to reduction treatment, a starting material gas containing hydrogen and dimethyl ether at a molar ratio of hydrogen:dimethyl ether=10:1 was allowed to flow through the catalyst layer at a reaction temperature of 385° C. to 475° C., at a reaction pressure of 2.0 MPa, and at W/F=1.0 g·h/mol. Thus, LPG synthesis reaction was carried out.

1 hour after the initiation of reaction, each product was analyzed by gas chromatography. Then, the conversion rate (%) of dimethyl ether, the proportion of carbon monoxide and carbon dioxide (collectively referred to as “COx”) in a product (i.e., the COx selection rate (%)), the proportion of hydrocarbon (referred to as “CH”) in a product (i.e., the CH selection rate (%)), and each hydrocarbon composition (%) of each generated hydrocarbon gas were determined. Each proportion was calculated in terms of the carbon amount.

In addition, the dimethyl ether conversion rate was calculated by the following formula.

Dimethyl ether conversion rate (%)=[(inlet dimethyl ether flow rate (mol/h)−outlet dimethyl ether flow rate (mol/h))/inlet dimethyl ether flow rate (mol/h)]×100

Table 1 lists analysis results. In Examples 1 and 2, the dimethyl ether (DME) conversion rate was 100%, the hydrocarbon selection rate was 99% or more, and the combined proportion of propane and butane contained in produced hydrocarbon was 68% or more. In particular, when the temperature was increased to 415° C. or more in Examples 1 and 2, the combined proportion of propane and butane contained in hydrocarbon exceeded 75%. This was a surprising result. Meanwhile, in Comparative Examples 1 to 3 in which β zeolite having an SiO₂ Al₂O₃ molar ratio of 37:1 was used, the combined proportion of propane and butane contained in the hydrocarbon did not exceed 70%, even though the loaded Pd content and the reaction temperature were increased.

TABLE 1

| | DME | COx | CH | Hydrocarbon composition (%) | | | | |
|---|---|---|---|---|---|---|---|---|
| Temperature ° C. | conversion rate (%) | selection rate (%) | selection rate (%) | CH4 | C2H4 | C2H6 | C3H6 | C3H8 |

Comparative Example 1 catalyst: Pd (0.05% by weight) -β-37

| | | | | | | | | |
|---|---|---|---|---|---|---|---|---|
| 385 | 95 | 0.4 | 99.6 | 17.8 | 0 | 1.9 | 0 | 27.6 |
| 400 | 97 | 0.5 | 99.5 | 10.9 | 0 | 2.3 | 0 | 31 |
| 415 | 100 | 0.2 | 99.8 | 1.5 | 0 | 5.2 | 0 | 30.4 |
| 430 | 100 | 0.2 | 99.8 | 1.3 | 0 | 7.5 | 0 | 30.4 |
| 450 | 100 | 0.2 | 99.8 | 2.3 | 0 | 10.3 | 0 | 30.5 |
| 475 | 100 | 0.3 | 99.7 | 6.4 | 0 | 12 | 0 | 32.7 |

Comparative Example 2 catalyst: Pd (0.1% by weight) -β-37

| | | | | | | | | |
|---|---|---|---|---|---|---|---|---|
| 385 | 96 | 0.9 | 99.1 | 23.5 | 0 | 1.5 | 0 | 21 |
| 400 | 100 | 0.4 | 99.6 | 2.5 | 0 | 3.6 | 0 | 25.8 |
| 415 | 100 | 0.3 | 99.7 | 1.1 | 0 | 5.2 | 0 | 26.6 |
| 430 | 100 | 0.4 | 99.6 | 1.5 | 0 | 6.9 | 0 | 28.6 |
| 450 | 100 | 0.3 | 99.7 | 2.4 | 0 | 8.4 | 0 | 30.7 |
| 475 | 100 | 0.3 | 99.7 | 5.3 | 0 | 9.8 | 0 | 30.2 |

Comparative Example 3 catalyst: Pd (0.5% by weight) -β-37

| | | | | | | | | |
|---|---|---|---|---|---|---|---|---|
| 385 | 98 | 3.2 | 96.8 | 97.5 | 0 | 0.3 | 0 | 2.2 |
| 400 | 96 | 2.9 | 97.1 | 93.7 | 0 | 0.4 | 0 | 5.9 |
| 415 | 97 | 3.9 | 96.1 | 92.7 | 0 | 1 | 0 | 6.3 |
| 430 | 98 | 4.7 | 95.3 | 70.9 | 0 | 1.7 | 0 | 12.9 |
| 450 | 100 | 4.4 | 95.6 | 27.4 | 0 | 2.1 | 0 | 30.5 |
| 475 | 100 | 0.6 | 99.4 | 5.3 | 0 | 11.3 | 0 | 25.6 |

Example 1 catalyst: Pd (0.5% by weight) -β-150

| | | | | | | | | |
|---|---|---|---|---|---|---|---|---|
| 385 | 100 | 0.1 | 99.9 | 1.8 | 0 | 1.1 | 0 | 26.1 |
| 400 | 100 | 0.1 | 99.9 | 1.4 | 0 | 1.4 | 0 | 32.6 |
| 415 | 100 | 0.1 | 99.9 | 1.3 | 0 | 1.8 | 0 | 37.1 |
| 430 | 100 | 0.2 | 99.8 | 1.5 | 0 | 2.2 | 0 | 42.3 |
| 450 | 100 | 0.3 | 99.7 | 2.1 | 0 | 3.2 | 0 | 46.9 |
| 475 | 100 | 0.5 | 99.5 | 4.2 | 0 | 5.2 | 0 | 49.1 |

Example 2 catalyst: Pd (0.5% by weight) -β-243

| | | | | | | | | |
|---|---|---|---|---|---|---|---|---|
| 385 | 100 | 1.1 | 98.9 | 9.7 | 0 | 1 | 0 | 21.9 |
| 400 | 100 | 0.6 | 99.4 | 5 | 0 | 0.9 | 0 | 26.9 |
| 415 | 100 | 0.5 | 99.5 | 3.3 | 0 | 0.8 | 0 | 32.3 |
| 430 | 100 | 0.5 | 99.5 | 2.4 | 0 | 0.8 | 0 | 37.5 |
| 450 | 100 | 0.4 | 99.6 | 1.9 | 0 | 1.1 | 0 | 45.2 |
| 475 | 100 | 0.4 | 99.6 | 1.7 | 0 | 1.8 | 0 | 54 |

| | Hydrocarbon composition (%) | | | | | | C3 + C4 yield (%) |
|---|---|---|---|---|---|---|---|
| Temperature ° C. | i-C4H10 | n-C4H10 | C5 | C6 | C7+ | C3 + C4 | from DME |

Comparative Example 1 catalyst: Pd (0.05% by weight) -β-37

| | | | | | | | |
|---|---|---|---|---|---|---|---|
| 385 | 25 | 11.2 | 11.7 | 4.8 | 0 | 63.8 | 63.5 |
| 400 | 25 | 12.6 | 11.9 | 6.1 | 0 | 68.7 | 68.3 |
| 415 | 27 | 12.5 | 15.3 | 8.1 | 0 | 69.9 | 69.8 |
| 430 | 26.1 | 11.7 | 15.5 | 7.5 | 0 | 68.3 | 68.1 |
| 450 | 24 | 11 | 14.1 | 7.8 | 0 | 65.5 | 65.3 |
| 475 | 20.8 | 10 | 13.3 | 4.8 | 0 | 63.5 | 63.3 |

Comparative Example 2 catalyst: Pd (0.1% by weight) -β-37

| | | | | | | | |
|---|---|---|---|---|---|---|---|
| 385 | 23.1 | 10.2 | 11.7 | 5.4 | 3.6 | 54.2 | 53.8 |
| 400 | 27.8 | 12.7 | 16.3 | 9 | 2.3 | 66.2 | 66 |
| 415 | 27.7 | 12.5 | 17.3 | 8.1 | 1.4 | 66.8 | 66.6 |
| 430 | 27.1 | 12.5 | 17.1 | 6.3 | 0 | 68.2 | 68 |
| 450 | 25.5 | 12.7 | 16.2 | 4 | 0 | 69 | 68.7 |
| 475 | 23.3 | 11.6 | 15.1 | 4.7 | 0 | 65.2 | 64.9 |

Comparative Example 3 catalyst: Pd (0.5% by weight) -β-37

| | | | | | | | |
|---|---|---|---|---|---|---|---|
| 385 | 0 | 0 | 0 | 0 | 0 | 2.2 | 2.2 |
| 400 | 0 | 0 | 0 | 0 | 0 | 5.9 | 5.7 |
| 415 | 0 | 0 | 0 | 0 | 0 | 6.3 | 6 |
| 430 | 6.8 | 4.3 | 3 | 0.4 | 0 | 24 | 22.9 |
| 450 | 17.2 | 12.4 | 7.1 | 3.2 | 0 | 60.2 | 57.6 |
| 475 | 27.7 | 9.6 | 16.2 | 2.8 | 1.5 | 62.8 | 62.5 |

Example 1 catalyst: Pd (0.5% by weight) -β-150

| | | | | | | | |
|---|---|---|---|---|---|---|---|
| 385 | 28 | 17.1 | 15.5 | 8.6 | 1.9 | 71.2 | 71.1 |
| 400 | 24 | 18.3 | 14.8 | 7.5 | 0 | 74.8 | 74.8 |
| 415 | 21.4 | 18.4 | 13.9 | 6.1 | 0 | 76.9 | 76.8 |
| 430 | 18.8 | 18.3 | 12.6 | 4.3 | 0 | 79.5 | 79.3 |
| 450 | 16.8 | 17.1 | 11.1 | 2.9 | 0 | 80.8 | 80.6 |
| 475 | 15.4 | 15.4 | 9 | 1.6 | 0 | 79.9 | 79.5 |

Example 2 catalyst: Pd (0.5% by weight) -β-243

| | | | | | | | |
|---|---|---|---|---|---|---|---|
| 385 | 30.5 | 15.6 | 12.2 | 5.2 | 3.9 | 68 | 67.3 |
| 400 | 27.7 | 17.3 | 13.8 | 6.4 | 2 | 71.8 | 71.4 |
| 415 | 24.4 | 18.8 | 13.7 | 6.1 | 0.6 | 75.5 | 75.1 |
| 430 | 20.8 | 20.1 | 13.2 | 4.9 | 0.3 | 78.4 | 78.1 |
| 450 | 16.5 | 20.3 | 11.8 | 3.2 | 0 | 82 | 81.7 |
| 475 | 12.5 | 19.1 | 9.6 | 1.4 | 0 | 85.6 | 85.2 |

### Experiment 2)

In this Experiment, β-zeolite being loaded with Pd (0.5% by weight) and having an SiO₂:Al₂O₃ molar ratio of 300:1 was used as a catalyst.

For preparation of β-zeolite, materials similar to those used in Experiment 1 were used. First, sodium aluminate (0.14 g), a TEAOH aqueous solution (10.5 g), and deionized water (8.75 g) were mixed so as to be homogenized. Next, Silica LUDOX TM-40 (22.5 g) was added to the above mixture, followed by stirring and mixing for dissolution. Further, ammonium fluoride (0.056 g) was added thereto, followed by stirring and mixing for 60 minutes. The thus obtained batch mixture had the composition of Na₂O: TEAOH:Al₂O₃:SiO₂:H₂O:NH₄F=1.97:12.5:0.25:75:1050:0.75 (molar ratio). The batch mixture was placed in an autoclave and subjected to hydrothermal synthesis at a rate of rotation of 20 rpm and at 150° C. for 168 hours. 168 hours later, the autoclave was cooled with cold water. The content was subjected to suction filtration. The resultant was sufficiently washed with deionized water and dried overnight at 120° C. After drying, baking was carried out at 550° C. for 6 hours. The thus obtained product was confirmed to be β-zeolite with the use of an X-ray diffractometer.

The thus obtained β-zeolite having an SiO₂:Al₂O₃ molar ratio of 300:1 was loaded with Pd (0.5% by weight) in a manner similar to that used in Experiment 1.

The Pd-loaded β-zeolite was pulverized in the manner used in Experiment 1. A reaction tube with an inner diameter of 6 mm was filled with the pulverized catalyst (1 g). Then, prior to reaction, the catalyst was subjected to reduction treatment in a hydrogen stream at 400° C. for 2 hours.

After reduction treatment, a starting material gas containing hydrogen and dimethyl ether at a molar ratio of hydrogen:dimethyl ether=19:1 was allowed to flow through the catalyst layer at a reaction temperature of 450° C., at a reaction pressure of 1.0 MPa, and at W/F=7.0 g·h/mol. Thus, LPG synthesis reaction was carried out. 1 hour after the initiation of reaction, the product was analyzed by gas chromatography. Then, each hydrocarbon composition (%) of the generated hydrocarbon gas was determined. Analysis was continued for 1050 hours after the initiation of the reaction.

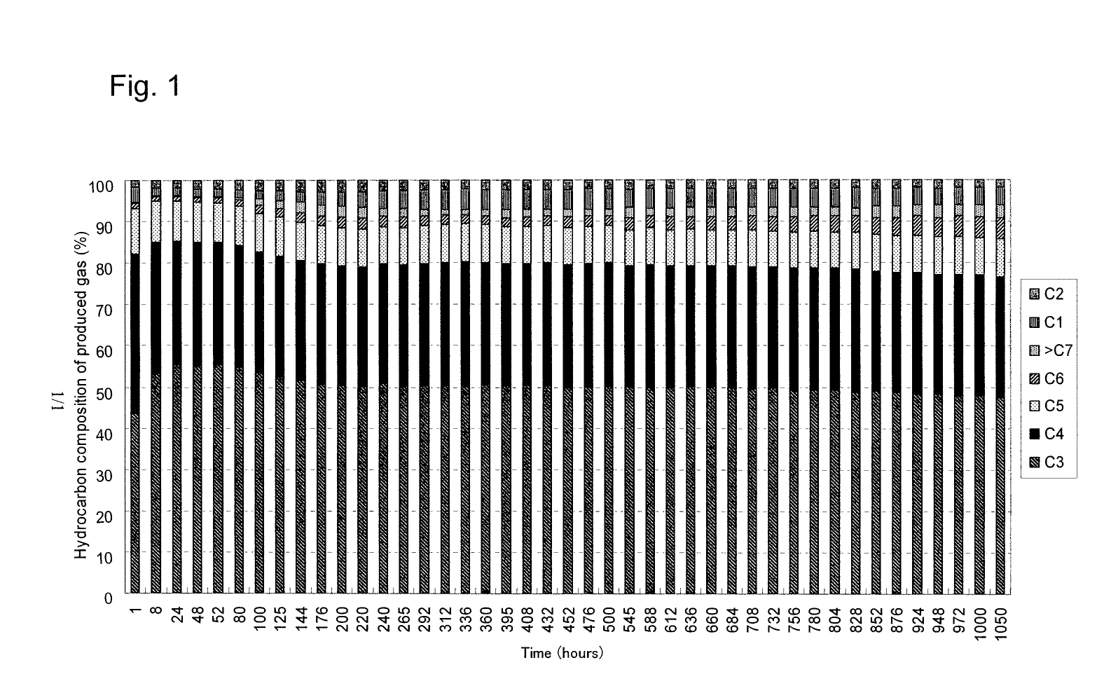

FIG. 1 shows the results. As shown in FIG. 1, at each time point from 1 hour after the initiation of the reaction to 1050 hours later, the combined proportion of propane and butane contained in the produced hydrocarbon exceeded 75%. This revealed that the catalyst of the present invention can maintain its activity for a long period of time.

All publications, patents, and patent applications cited herein are incorporated herein by reference in their entirety.

1. A catalyst for liquefied petroleum gas production for producing a liquefied petroleum gas mainly consisting of propane or butane by reacting at least one of methanol and dimethyl ether with hydrogen, which comprises a Pd-loaded β-zeolite having an SiO₂:Al₂O₃ molar ratio of 100 or more:1.

2. The catalyst for liquefied petroleum gas production according to claim 1, wherein the SiO₂:Al₂O₃ molar ratio is 100:1 to 1000:1.

3. The catalyst for liquefied petroleum gas production according to claim 1, wherein the loaded Pd content is 0.01% to 5.0% by weight.

4. A method for liquefied petroleum gas production, comprising reacting at least one of methanol and dimethyl ether with hydrogen in the presence of the catalyst for liquefied petroleum gas production according to claim 1 so as to produce a liquefied petroleum gas mainly consisting of propane or butane.

5. The method for liquefied petroleum gas production according to claim 4, wherein the reaction temperature for reacting at least one of methanol and dimethyl ether with hydrogen is 350° C. to 600° C.

6. The method for liquefied petroleum gas production according to claim 4, wherein the reaction pressure for reacting at least one of methanol and dimethyl ether with hydrogen is 0.5 to 5.0 MPa.

7. A method for liquefied petroleum gas production, comprising:
(A): a methanol production step of allowing a synthesis gas to flow through a catalyst layer containing a methanol synthesis catalyst so as to obtain a reaction gas containing methanol and hydrogen; and
(B): a liquefied petroleum gas production step of allowing the reaction gas obtained in the methanol production step to flow through a catalyst layer containing the catalyst for liquefied petroleum gas production according to claim 1 so as to produce a liquefied petroleum gas mainly consisting of propane or butane.

8. A method for liquefied petroleum gas production, comprising:
(A): a dimethyl ether production step of allowing a synthesis gas to flow through a catalyst layer containing a methanol synthesis catalyst and a methanol dehydration catalyst so as to obtain a reaction gas containing dimethyl ether and hydrogen; and
(B): a liquefied petroleum gas production step of allowing the reaction gas obtained in the dimethyl ether production step to flow through a catalyst layer containing the catalyst for liquefied petroleum gas production according to claim 1 so as to produce a liquefied petroleum gas mainly consisting of propane or butane.

9. A method for liquefied petroleum gas production, comprising:
(A): a synthesis gas production step of producing a synthesis gas with the use of a carbon-containing starting material and at least one member selected from the group consisting of H₂O, O₂, and CO₂;
(B): a methanol production step of allowing the synthesis gas to flow through a catalyst layer containing a methanol synthesis catalyst so as to obtain a reaction gas containing methanol and hydrogen; and
(C): a liquefied petroleum gas production step of allowing the reaction gas obtained in the methanol production step to flow through a catalyst layer containing the catalyst for liquefied petroleum gas production according to claim 1 so as to produce a liquefied petroleum gas mainly consisting of propane or butane.

10. A method for liquefied petroleum gas production, comprising:
(A): a synthesis gas production step of producing a synthesis gas with the use of a carbon-containing starting material and at least one member selected from the group consisting of H₂O, O₂, and CO₂;
(B): a dimethyl ether production step of allowing the synthesis gas to flow through a catalyst layer containing a methanol synthesis catalyst and a methanol dehydration catalyst so as to obtain a reaction gas containing dimethyl ether and hydrogen; and
(C): a liquefied petroleum gas production step of allowing the reaction gas obtained in the dimethyl ether production step to flow through a catalyst layer containing the catalyst for liquefied petroleum gas production according to claim 1 so as to produce a liquefied petroleum gas mainly consisting of propane or butane.
